(19) United States
(12) Patent Application Publication
(10) Pub. No.: US 2021/0023641 A1
(43) Pub. Date: Jan. 28, 2021

(54) SYSTEMS AND METHODS PROVIDING HIGH SPEED LASER HOT WIRE SPRAY

(71) Applicant: Lincoln Global, Inc., Santa Fe Springs, CA (US)

(72) Inventor: Kyle G. Smith, Willoughby, OH (US)

(21) Appl. No.: 16/522,784

(22) Filed: Jul. 26, 2019

(51) Int. Cl. B23K 9/10; B23K 26/14; B23K 9/133; B23K 9/12

(52) U.S. Cl. CPC B23K 9/1093; B23K 26/1464; B23K 9/1012; B23K 9/124; B23K 9/1336

(57) ABSTRACT

Embodiments of a high speed laser hot wire spraying system are disclosed. In one embodiment, a laser subsystem includes a laser power oscillator and a laser focusing device to generate a laser beam directed toward a substrate. The laser focusing device includes a high velocity coaxial gas nozzle to direct, coaxially with the laser beam, a stream of inert gas toward the substrate. A hot wire subsystem includes a power supply and a wire feeding device to feed a consumable metal wire toward the laser beam while resistively pre-heating a distal portion of the consumable metal wire. The laser beam provides energy to liquefy the distal portion of the consumable metal wire upon intersecting the laser beam. The stream of inert gas has a velocity to cause the distal portion of the consumable metal wire to be sprayed as liquefied particles onto a surface of the substrate.

### REFERENCE

The disclosure of U.S. Pat. No. 9,409,250, issued on Aug. 9, 2016, is incorporated herein by reference in its entirety. The disclosure of U.S. Pat. No. 9,114,483, issued on Aug. 25, 2015, is incorporated herein by reference in its entirety.

### FIELD

Embodiments of the present invention relate to systems and methods for coating of metal materials, and more specifically to using a metal wire that is resistance heated and then melted by a laser source and transferred to a substrate by means of a coaxial high velocity gas to deposit a thin layer of metal onto a surface of the substrate.

### BACKGROUND

Hard chrome plating of materials is becoming less and less desirable due to environmental concerns associated with the process. Technologies such as laser hotwire, thermal spraying, and high speed laser powder deposition exist, but currently may not always provide an efficient means for depositing very thin layers of high hardness/corrosion-resistant metal material onto components as desired by laser cladding facilities. A high speed laser powder process or a thermal spraying process may be sufficient in some cases. However, powder processes have certain inherent problems such as feeding, humidity, health risks, waste, and cost, for example.

### SUMMARY

Embodiments of the present invention include systems and methods related to using a metal wire that is resistance heated and then melted by a laser source and transferred to a substrate by means of a coaxial high velocity gas to deposit a thin layer of metal onto a surface of the substrate. One embodiment includes a high speed laser hot wire spraying system. The system includes a laser subsystem including a laser power oscillator and a laser focusing device configured to generate a laser beam directed toward a substrate that is external to the laser subsystem. The laser focusing device includes a high velocity coaxial gas nozzle configured to form and direct, coaxially with the laser beam, a stream of inert gas toward the substrate. The system also includes a source of consumable metal wire and a hot wire subsystem. In one embodiment, the consumable metal wire includes chromium. The hot wire subsystem includes a power supply and a wire feeding device configured to feed a consumable metal wire from the source of consumable metal wire toward the laser beam while resistively pre-heating a distal portion of the consumable metal wire before intersecting the laser beam. In one embodiment, the wire feeding device includes a motor and drive rollers. The laser beam provides energy to liquefy the distal portion of the consumable metal wire upon intersecting the laser beam. The stream of inert gas has a velocity to cause the distal portion of the consumable metal wire, as liquefied by the laser beam, to be sprayed as liquefied particles onto a surface of the substrate. In one embodiment, the hot wire subsystem further includes a wire contact device, having an anode and a cathode, operatively connected to the wire feeding device and the power supply and configured to resistively pre-heat the distal portion of the consumable metal wire. One embodiment includes a rotatable fixture configured to hold and rotate the substrate as the distal portion of the consumable metal wire is sprayed as the liquefied particles onto the surface of the substrate while rotating. In one embodiment, the laser subsystem includes a source of the inert gas, an inert gas pressure regulator, and an inert gas inlet on the laser focusing device configured to direct the inert gas toward the high velocity coaxial gas nozzle. In one embodiment, the laser focusing device includes at least one of a laser light focusing optics module, an inert gas inlet, a focusing optics cover slide, and a focusing optics outlet tip. In one embodiment, spraying of the distal portion of the consumable metal wire as the liquefied particles results in a deposition of a layer of the consumable metal wire onto the substrate having a thickness of at least 0.050 mm and less than 0.101 mm. In one embodiment, the laser beam is a single beam path laser beam that is not split or recombined within the laser subsystem. In one embodiment, the laser subsystem operates in the infrared spectrum providing an output power of up to 15 kilowatts.

In one embodiment, a laser focusing device is provided. The laser focusing device includes a laser light focusing optics module configured to receive laser light, generated by a laser power oscillator, and focus the laser light into a laser beam directed toward a substrate that is external to the laser focusing device. The laser focusing device also includes an inert gas inlet configured to receive an inert gas from a pressurized source of the inert gas that is external to the laser focusing device, and a high velocity coaxial gas nozzle configured to form and direct, coaxially with the laser beam, a stream of the inert gas toward the substrate. The laser beam has energy to liquefy a resistively pre-heated portion of a consumable metal wire that intersects the laser beam external to the laser focusing device. The stream of the inert gas has a velocity to cause the resistively pre-heated portion of the consumable metal wire, as liquefied by the laser beam, to be sprayed as liquefied particles onto a surface of the substrate. In one embodiment, the laser focusing device includes at least one of a focusing optics cover slide and a focusing optics outlet tip. In one embodiment, spraying of the distal portion of the consumable metal wire as the liquefied particles results in a deposition of a layer of the consumable metal wire onto the substrate having a thickness of at least 0.050 mm and less than 0.101 mm. In one embodiment, the laser beam is a single beam path laser beam that is not split or recombined. In one embodiment, the laser focusing device operates in the infrared spectrum and the laser beam provides an output power of up to 15 kilowatts.

In one embodiment, a method of applying a metal coating to a substrate is provided. The method includes forming a laser beam with a laser subsystem and directing the laser beam toward a substrate that is external to the laser subsystem. The method also includes forming a stream of inert gas that is coaxial with the laser beam using a high velocity coaxial gas nozzle and directing the stream of inert gas toward the substrate. The method further includes resistively pre-heating a distal portion of a consumable metal wire with a hot wire subsystem and feeding the distal portion of the consumable metal wire toward the laser beam. The method also includes intersecting the distal portion of the consumable metal wire, as resistively pre-heated and fed, with the laser beam and the stream of inert gas causing the distal portion of the consumable metal wire to be liquefied by the laser beam and sprayed by the stream of inert gas as liquefied particles onto a surface of the substrate. In one embodiment, the method includes holding and rotating the substrate with a rotatable fixture as the distal portion of the consumable metal wire is sprayed as the liquefied particles onto the surface of the substrate while rotating. In one embodiment, the method includes regulating a pressure of the inert gas with a pressure regulator to achieve a velocity of the stream of inert gas out of the high velocity coaxial gas nozzle that allows the liquefied particles to be formed and sprayed. In one embodiment, an amplitude of the laser beam is modulated by a modulation circuit of the laser subsystem to control an amount of energy delivered by the laser beam to the distal portion of the consumable metal wire. In one embodiment, the consumable metal wire includes chromium.

Numerous aspects of the general inventive concepts will become readily apparent from the following detailed description of exemplary embodiments and from the accompanying drawings.

### BRIEF DESCRIPTION OF THE DRAWINGS

The accompanying drawings, which are incorporated in and constitute a part of the specification, illustrate various embodiments of the disclosure. It will be appreciated that the illustrated element boundaries (e.g., boxes, groups of boxes, or other shapes) in the figures represent one embodiment of boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates a conventional laser hot wire (LHW) system using a laser and a resistively heated wire in a deposition process;

FIG. 2 illustrates one embodiment of a high speed laser hot wire spraying system;

FIG. 3 illustrates one embodiment of a laser focusing device of the high speed laser hot wire spraying system of FIG. 2;

FIG. 4 illustrates a flow chart of one embodiment of a method of applying a metal coating to a substrate using the high speed laser hot wire spraying system of FIG. 2; and

FIG. 5 illustrates one embodiment of an example controller used in the high speed laser hot wire spraying system of FIG. 2.

### DETAILED DESCRIPTION

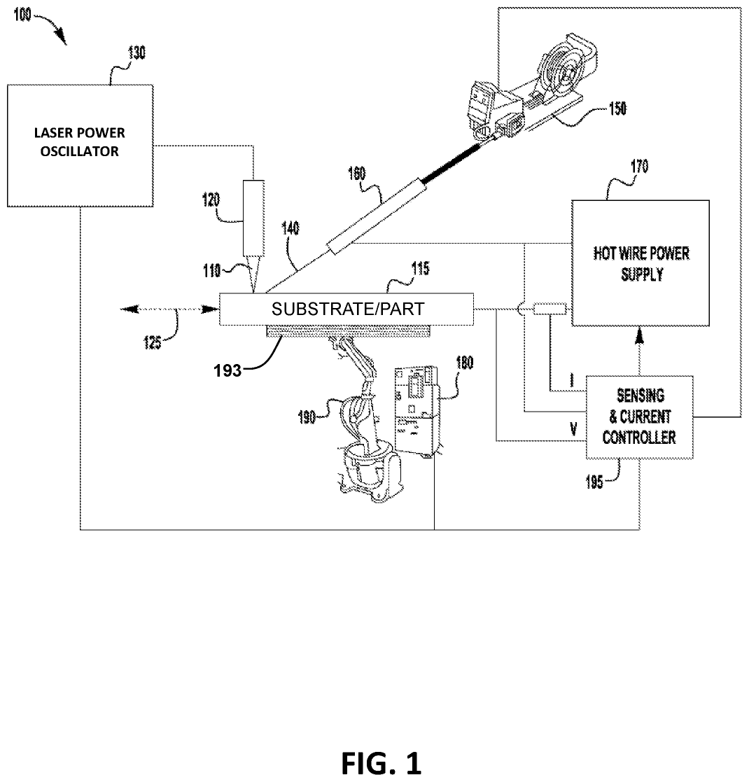

The examples and figures herein are illustrative only and are not meant to limit the subject invention, which is measured by the scope and spirit of the claims. Certain types of laser hot wire systems are known in the art. For example, FIG. 1 illustrates a conventional laser hot wire (LHW) system 100 using a laser and a resistively heated wire in a deposition process. The system 100 of FIG. 1 includes a wire feeder and an energy source. In particular, the system 100 includes a laser subsystem capable of focusing a laser beam 110 onto a substrate or part 115 to heat the substrate or part 115. The laser subsystem may be a high intensity energy source. The laser subsystem can be any type of high energy laser source, including but not limited to carbon dioxide, Nd:YAG, Yb-disk, YB-fiber, fiber delivered, or direct diode laser systems (e.g., fiber-coupled direct diode).

The laser subsystem includes a laser focusing device 120 and a laser power supply 130 (laser power oscillator) operatively connected to each other. The laser power supply 130 provides power to generate the laser energy that is provided (e.g., fiber-optically) to the laser focusing device 120. The system 100 also includes a hot filler wire feeder subsystem capable of providing at least one resistive filler wire 140 to make contact with the substrate or part 115 in the vicinity of the laser beam 110. The wire feeder subsystem includes a wire feeder 150, a contact tube 160, and a power supply 170. During operation, the filler wire 140 is resistance-heated by electrical current from the power supply 170 which is operatively connected between the contact tube 160 and the substrate or part 115. The power supply 170 may be a pulsed direct current (DC) power supply, although alternating current (AC) or other types of power supplies are possible as well. The wire 140 is fed from the wire feeder 150 through the contact tube 160 toward the substrate or part 115 and extends beyond the tube 160. The extension portion of the wire 140 is resistance-heated such that the extension portion approaches or reaches the melting point before contacting the substrate or part 115. The hot wire power supply 170 may provide hot wire waveform control (active augmentation of current, voltage, and shape parameters) to sustain a hot wire process and suppress arcing. The laser beam 110 may serve to melt some of the base metal of the substrate or part 115 to form a puddle and/or can also be used to melt the wire 140 onto the substrate or part 115. The power supply 170 provides energy needed to resistance-melt the filler wire 140.

The system 100 further includes a motion control subsystem capable of moving the laser beam 110 and the resistive filler wire 140 in a same controlled direction 125 along the substrate or part 115 (at least in a relative sense) such that the laser beam 110 and the resistive filler wire 140 remain in a fixed relation to each other. The relative motion between the substrate or part 115 and the laser/wire combination may be achieved by actually moving the substrate or part 115 or by moving the laser device 120 and the wire feeder subsystem.

In FIG. 1, the motion control subsystem includes a motion controller 180 operatively connected to a robot 190 having a platform 193 (e.g., a rotatable and/or translatable platform). The motion controller 180 controls the motion of the robot 190. The robot 190 is operatively connected (e.g., mechanically secured) to the substrate or part 115 via the platform 193 to move the substrate or part 115 in, for example, a present direction of travel 125 such that the laser beam 110 and the wire 140 effectively travel along the substrate or part 115. The robot 190 driving the platform 193 may be driven electrically, pneumatically, or hydraulically.

The system 100 further includes a sensing and current control subsystem 195 which is operatively connected to the substrate or part 115 and the contact tube 160 (i.e., effectively connected to the output of the power supply 170) and is capable of measuring a potential difference (i.e., a voltage V) between and a current (I) through the substrate or part 115 and the wire 140. The sensing and current control subsystem 195 may further be capable of calculating a resistance value (R=V/I) and/or a power value (P=V*I) from the measured voltage and current. In general, when the wire 140 is in contact with the substrate or part 115, the potential difference between the wire 140 and the substrate or part 115 is zero volts or very nearly zero volts (a relatively low voltage). As a result, the sensing and current control subsystem 195 is capable of sensing when the resistive filler wire 140 is in contact with the substrate or part 115 and is operatively connected to the power supply 170 to be further capable of controlling the flow of current through the resistive filler wire 140 in response to the sensing (e.g., for arc suppression). The sensing and current controller 195 may be an integral part of the power supply 170.

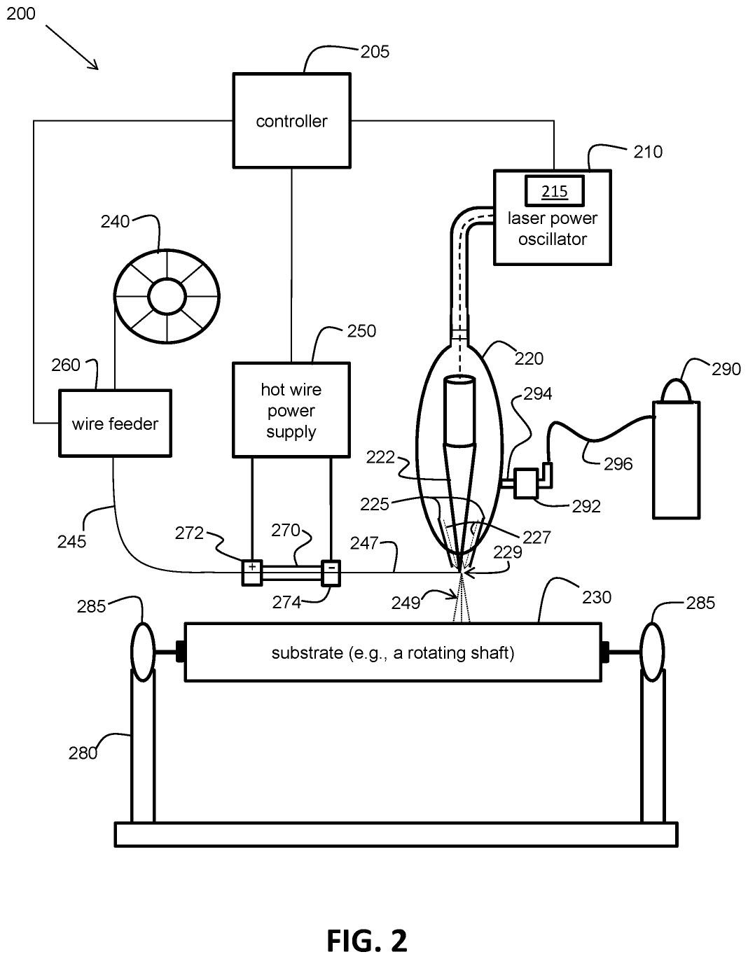

FIG. 2 illustrates a high speed laser hot wire spraying system 200, in accordance with one embodiment of the present invention. The system 200 of FIG. 2 is configured to spray a thin layer (e.g., having a thickness of at least 0.050 mm and less than 0.101 mm) of metal material onto a substrate to coat a surface of the substrate. The metal material may include chromium, for example, and the substrate may include mild steel. Other types of metal materials for coating mild steel substrates or other types of substrates are possible as well. The system 200 may include elements/components that are similar to at least some of the elements/components of FIG. 1, in accordance with various embodiments.

For example, the system 200 includes a laser subsystem having a laser power oscillator 210 and a laser focusing device 220 configured to generate a high power density laser beam 222 directed toward a substrate 230 that is external to the laser subsystem. The laser beam 222 is focused above the substrate 230. In accordance with one embodiment, the laser beam 222 may be produced from fiber-delivered laser energy. However, the laser subsystem can be any type of high energy laser source, including but not limited to carbon dioxide, Nd:YAG, Yb-disk, YB-fiber, fiber delivered, or direct diode laser systems (e.g., fiber-coupled direct diode).

In accordance with one embodiment, the laser beam is a single beam path laser beam that is not split or recombined within the laser subsystem. Also, the laser subsystem operates in the infrared spectrum providing an output power of up to 15 kilowatts, in accordance with one embodiment. The laser focusing device 220 includes a high velocity coaxial gas nozzle 225 configured to direct, coaxially with the laser beam 222, a stream of inert gas 227 toward the substrate 230. That is, the stream of inert gas 227 coaxially surrounds the laser beam 222, in accordance with one embodiment.

The system 200 also includes a source 240 of consumable metal wire 245 and a hot wire subsystem. The hot wire subsystem includes a power supply 250 and a wire feeding device 260 configured to feed the consumable metal wire 245 from the source 240 toward the laser beam 222 while resistively pre-heating a distal portion 247 of the consumable metal wire 245 before the distal portion 247 intersects the laser beam 222. In accordance with one embodiment, the wire feeding device 260 includes a motor and drive rollers (not shown). For example, the wire feeding device 260 may include a servo-control drive (servo motor) to drive the drive rollers, providing stable and precise feeding of the consumable metal wire. In one embodiment, the consumable metal wire moves toward the laser beam 222 via a conduit. An integrated wire feeder circuit control board (not shown) may be used to control the motor, in accordance with one embodiment.

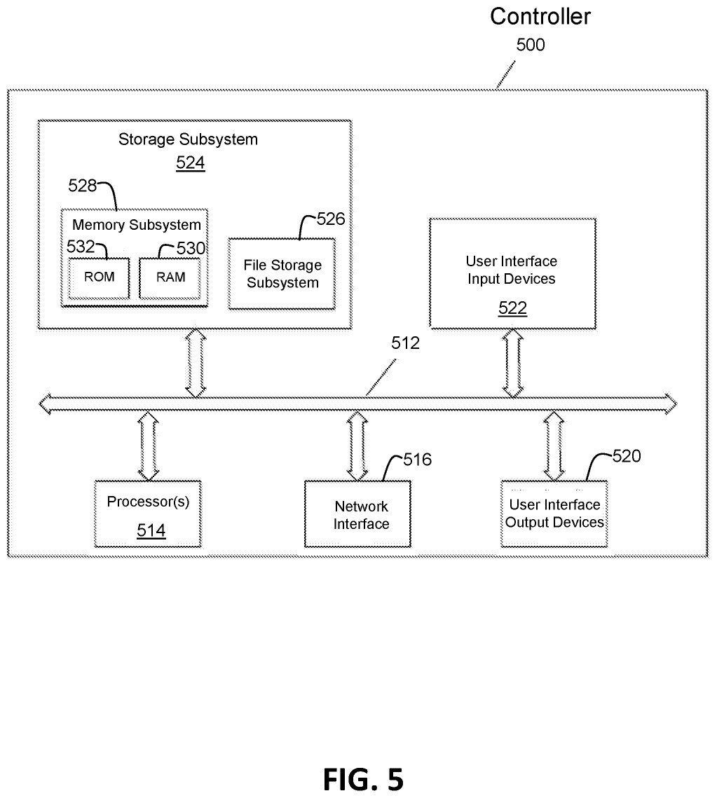

The system 200 also includes a master controller 205 operatively connected to at least the wire feeding device 260, the hot wire power supply 250, and the laser power oscillator 210. The controller 205 is configured to control various elements of the system 200 to perform the coating function. An example embodiment of such a controller is discussed herein with respect to FIG. 5. In accordance with an alternative embodiment, the master controller 205 may be broken up into several controllers. For example, there may be one controller for the wire feeding device 260, one controller for the hot wire power supply 250, and another controller for the laser power oscillator 210. Other controller configurations are possible as well, in accordance with other embodiments.

The hot wire subsystem includes a wire contact device 270 having an anode 272 and a cathode 274. The wire contact device 270 is operatively connected to the wire feeding device 260 and the power supply 250 and is configured to resistively pre-heat the distal portion 247 of the consumable metal wire 245. As the distal portion 247 of the consumable metal wire 245 is fed through the wire contact device 270 by the wire feeding device 260, contact is made at the anode 272 and the cathode 274. This results in the power supply 250 passing an electric current through the consumable metal wire between the anode 272 and the cathode 274. This causes the wire to pre-heat due to the electrical resistance of the wire 245. However, the wire does not fully melt and maintains enough integrity to be fed toward the laser beam 222.

The laser beam 222 has enough energy to liquefy the distal portion 247 of the consumable metal wire 245, as pre-heated, upon intersecting the laser beam 222 at a location of intersection 229 (e.g., the focal point of the laser beam 222). In one embodiment, the laser power oscillator 210 of the laser subsystem includes a modulation circuit 215 for modulating an amplitude of the laser beam 222 (e.g., via pulsing) to control an amount of energy that the laser beam 222 delivers to the distal portion 247 of the consumable metal wire 245. The modulation circuit 215 may be, for example, optical, electrical, or some combination thereof, in accordance with various embodiments. Furthermore, the stream of inert gas 227 has enough velocity (due to at least the pressure of the inert gas coming into the laser focusing device 220 and the high velocity coaxial gas nozzle 225) to cause the distal portion 247 of the consumable metal wire 245, as liquefied by the laser beam 222, to be sprayed as liquefied particles 249 onto a surface of the substrate 230.

The system 200 also includes a rotatable fixture 280 to hold and rotate the substrate 230 as the distal portion 247 of the consumable metal wire 245 is sprayed as liquefied particles 249 onto the surface of the substrate 230 while rotating. For example, in one embodiment, the substrate 230 may be a rotatable shaft or pipe (e.g., in a cylindrical shape). The rotatable fixture 280 may include, for example, synchronized motors 285 to perform the rotating. The rate of rotation may be set, in accordance with one embodiment, to achieve a thin layer (e.g., at least 0.050 mm and less than 0.101 mm) of coated metal material on the surface of the substrate 230. The liquefied particles 249 adhere to the substrate and solidify, due to cooling, to form the thin layer.

Furthermore, in accordance with one embodiment, the fixture 280 may be configured to be translated (e.g., horizontally) as the substrate 230 is rotated, allowing the entire surface of the substrate 230 to be coated. For example, a robotic system similar to that of FIG. 1 (having a motion controller 180, a robot 190, and a platform 193) may be employed in the system 200 of FIG. 2 to perform the translation of the fixture 280, in accordance with one embodiment. In an alternative embodiment, a robotic system similar to that of FIG. 1 may be employed in the system 200 of FIG. 2 to move, for example, the laser focusing device 220 (and possibly one or more of the wire feeding device 260, the power supply 250, and the wire contact device 270) with respect to the substrate 230 as the substrate 230 rotates on the fixture 280.

The laser subsystem of the system 200 also includes a source 290 of inert gas (e.g., argon), an inert gas pressure regulator 292, and an inert gas inlet 294 on the laser focusing device 220. Referring to FIG. 2, the source of inert gas 290 is connected (e.g., via a hose 296) to the inert gas pressure regulator 292, and the inert gas pressure regulator 292 is connected to the inert gas inlet 294. In this manner, an inert gas from the source 290 is directed toward and into the laser focusing device 220, having the high velocity coaxial gas nozzle 225, to form the stream of inert gas 227 coaxially with the laser beam 222. The pressure regulator 292 can be adjusted to set the velocity of the stream of inert gas 227 to a velocity that is sufficient to form and spray the liquefied particles 249. In an alternative embodiment, the inert gas pressure regulator 292 may not be needed if the pressure out of the source 290 (along with the high velocity coaxial gas nozzle 225) is sufficient to form the spray of the liquefied particles 249.

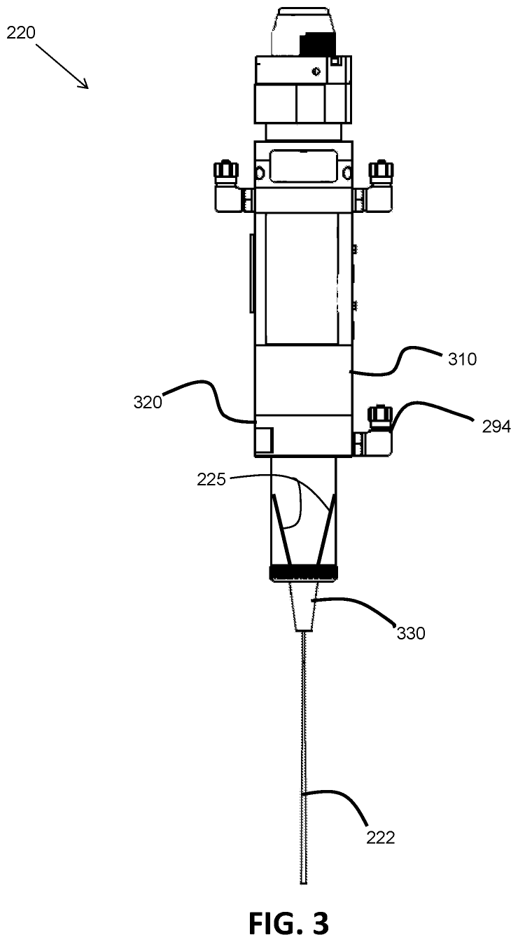

FIG. 3 illustrates one embodiment of the laser focusing device 220 of the high speed laser hot wire spraying system 200 of FIG. 2. The laser focusing device 220 forms the laser beam 222 via focusing techniques. The laser focusing device 220 includes a laser light focusing optics module 310 configured to receive laser light, generated by the laser power oscillator 210, and focus the laser light to produce the laser beam 222. The laser beam 222 is directed toward the substrate 230 which is external to the laser focusing device 220.

In accordance with one embodiment, the laser beam 222 is a single beam path laser beam that is not split or recombined. The laser focusing device 220 operates in the infrared spectrum and the laser beam 222 provides an output power of up to 15 kilowatts. The laser focusing device 220 includes the high velocity coaxial gas nozzle 225 and the inert gas inlet 294 as discussed above herein. The inert gas inlet 294 is configured to receive an inert gas from a pressurized source 290 of the inert gas which is external to the laser focusing device 220. The high velocity coaxial gas nozzle 225 is configured to form and direct, coaxially with the laser beam 222, a stream 227 of the inert gas toward the substrate 230.

The coaxial laser/inert gas configuration also helps to keep debris from moving toward the optics of the laser focusing device 220. The laser focusing device 220 includes a focusing optics cover slide 320 which is configured as a sacrificial focusing optics cover slide and also helps to protect the optics. For example, the cover slide 320 helps to prevent unwanted material/particles (e.g., spatter, fumes) from getting up into the focusing optics module 310. Gas (e.g., argon) coming into the inert gas inlet 294 also helps to prevent unwanted material/particles (e.g., spatter, fumes) from getting up into the focusing optics module 310. The laser focusing device 220 also includes a focusing optics outlet tip 330. The high velocity coaxial gas nozzle 225 and the focusing optics outlet tip 330 both help to create a blast of gas that helps prevent material/particles (e.g., splatter, fumes) from getting back to the focusing optics module 310.

Again, the laser beam 222 has enough energy to liquefy a resistively pre-heated portion 247 of the consumable metal wire 245 that intersects the laser beam 222 external to the laser focusing device 220. The stream of inert gas 227 has a velocity to cause the resistively pre-heated portion 247 of the consumable metal wire 245, as liquefied by the laser beam 222, to be sprayed as liquefied particles 249 onto the surface of the substrate 230.

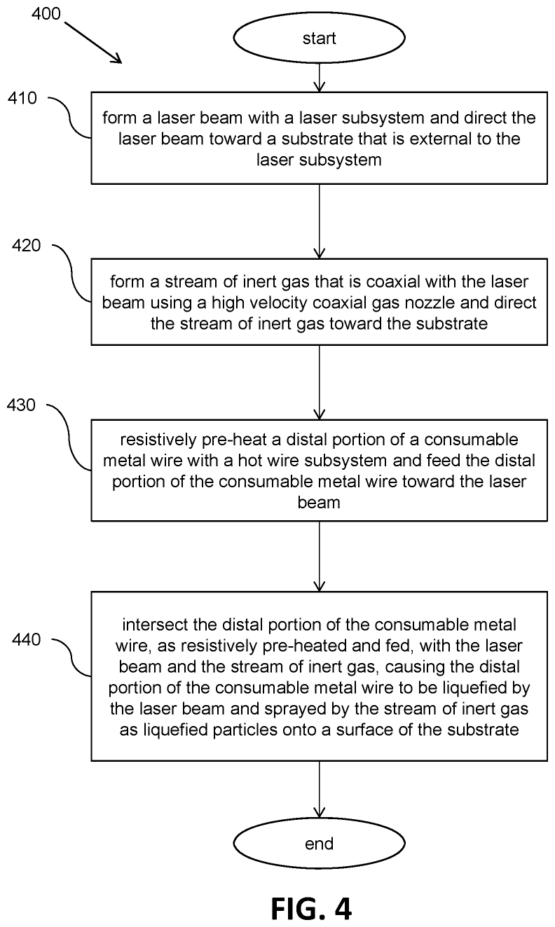

FIG. 4 illustrates a flow chart of one embodiment of a method 400 of applying a metal coating to a substrate using the high speed laser hot wire spraying system 200 of FIG. 2. At block 410, a laser beam is formed using a laser subsystem, and the laser beam is directed toward a substrate that is external to the laser subsystem. At block 420, a stream of inert gas is formed that is coaxial with the laser beam using a high velocity coaxial gas nozzle, where the stream of inert gas is directed toward the substrate. At block 430, a distal portion of a consumable metal wire is resistively pre-heated by a hot wire subsystem and is fed toward the laser beam. At block 440, the distal portion of the consumable metal wire, as resistively pre-heated, intersects the laser beam and the stream of inert gas, causing the distal portion of the consumable metal wire to be liquefied by the laser beam and sprayed by the stream of inert gas as liquefied particles onto a surface of the substrate.

In accordance with one embodiment, the method also includes holding and rotating the substrate, via a rotatable fixture, as the distal portion of the consumable metal wire is sprayed as the liquefied particles onto the surface of the substrate while rotating. The method may also include regulating a pressure of the inert gas with a pressure regulator to achieve a velocity of the stream of inert gas out of the high velocity coaxial gas nozzle that allows the liquefied particles to be formed and sprayed. Furthermore, in accordance with one embodiment, the method includes modulating an amplitude of the laser beam with a modulation circuit of the laser subsystem to control an amount of energy of the laser beam that is delivered to the distal portion of the consumable metal wire. Similarly, in accordance with one embodiment, the method includes modulating an amplitude of the current through the distal portion of the consumable metal wire with a modulation circuit of the hot wire subsystem to control an amount of energy that is delivered to the distal portion of the consumable metal wire to pre-heat the distal portion.

FIG. 5 illustrates one embodiment of an example controller 500 used in the high speed laser hot wire spraying system 200 of FIG. 2 (e.g., the controller 205 of FIG. 2). The controller 500 may also be used as, for example, a motion controller (e.g., the motion controller 180 of FIG. 1), as a controller of a power supply (e.g., the laser power supply 130 of FIG. 1 and/or the hot wire power supply 170 of FIG. 1), or as a controller of a wire feeding device of FIG. 1 or FIG. 2, in accordance with various embodiments.

The controller 500 includes at least one processor 514 which communicates with a number of peripheral devices via bus subsystem 512. These peripheral devices may include a storage subsystem 524, including, for example, a memory subsystem 528 and a file storage subsystem 526, user interface input devices 522, user interface output devices 520, and a network interface subsystem 516. The input and output devices allow user interaction with the controller 500. Network interface subsystem 516 provides an interface to outside networks and is coupled to corresponding interface devices in other computer systems. For example, the motion controller 180 of the system 100 may share one or more characteristics with the controller 500 and may be, for example, a conventional computer, a digital signal processor, and/or other computing device.

User interface input devices 522 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into the controller 500 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from the controller 500 to the user or to another machine or computer system.

Storage subsystem 524 stores programming and data constructs that provide or support some or all of the functionality described herein (e.g., as software modules). For example, the storage subsystem 524 may include various programmable modulation schemes for controlling the modulation circuit 215 for modulating an amplitude of the laser beam 222 (e.g., via pulsing) to control an amount of energy that the laser beam 222 delivers to the distal portion 247 of the consumable metal wire 245.

Software modules are generally executed by processor 514 alone or in combination with other processors. Memory 528 used in the storage subsystem can include a number of memories including a main random access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain embodiments may be stored by file storage subsystem 526 in the storage subsystem 524, or in other machines accessible by the processor(s) 514.

Bus subsystem 512 provides a mechanism for letting the various components and subsystems of the controller 500 communicate with each other as intended. Although bus subsystem 512 is shown schematically as a single bus, alternative embodiments of the bus subsystem may use multiple buses.

The controller 500 can be configured as any of various types including a microprocessor and other components on a printed circuit board (PCB), a workstation, a server, a computing cluster, a blade server, a server farm, or any other data processing system or computing device. Due to the ever-changing nature of computing devices and networks, the description of the controller 500 depicted in FIG. 5 is intended only as a specific example for purposes of illustrating some embodiments. Many other configurations of the controller 500 are possible having more or fewer components than the controller depicted in FIG. 5.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or illustrative examples shown and described. Thus, this disclosure is intended to embrace alterations, modifications, and variations that fall within the scope of the appended claims, which satisfy the statutory subject matter requirements of 35 U.S.C. § 101. The above description of specific embodiments has been given by way of example. From the disclosure given, those skilled in the art will not only understand the general inventive concepts and attendant advantages, but will also find apparent various changes and modifications to the structures and methods disclosed. It is sought, therefore, to cover all such changes and modifications as fall within the spirit and scope of the general inventive concepts, as defined by the appended claims, and equivalents thereof.

What is claimed is:

1. A high speed laser hot wire spraying system, the system comprising:
a laser subsystem including a laser power oscillator and a laser focusing device configured to generate a laser beam directed toward a substrate that is external to the laser subsystem, wherein the laser focusing device includes a high velocity coaxial gas nozzle configured to direct, coaxially with the laser beam, a stream of inert gas toward the substrate;
a source of consumable metal wire; and
a hot wire subsystem, including a power supply and a wire feeding device, configured to feed the consumable metal wire from the source toward the laser beam while resistively pre-heating a distal portion of the consumable metal wire before intersecting the laser beam,
wherein the laser beam provides an energy to liquefy the distal portion of the consumable metal wire upon intersecting the laser beam, and wherein the stream of inert gas has a velocity to cause the distal portion of the consumable metal wire, as liquefied by the laser beam, to be sprayed as liquefied particles onto a surface of the substrate.

2. The high speed laser hot wire spraying system of claim 1, wherein the hot wire subsystem further includes a wire contact device, having an anode and a cathode, operatively connected to the wire feeding device and the power supply and configured to resistively pre-heat the distal portion of the consumable metal wire.

3. The high speed laser hot wire spraying system of claim 1, further comprising a rotatable fixture configured to hold and rotate the substrate as the distal portion of the consumable metal wire is sprayed as the liquefied particles onto the surface of the substrate while rotating.

4. The high speed laser hot wire spraying system of claim 1, wherein the laser subsystem further includes a source of the inert gas, an inert gas pressure regulator, and an inert gas inlet on the laser focusing device configured to direct the inert gas toward the high velocity coaxial gas nozzle.

5. The high speed laser hot wire spraying system of claim 1, wherein the laser focusing device further includes at least one of a laser light focusing optics module, an inert gas inlet, a focusing optics cover slide, and a focusing optics outlet tip.

6. The high speed laser hot wire spraying system of claim 1, wherein spraying of the distal portion of the consumable metal wire as the liquefied particles results in a deposition of a layer of the consumable metal wire onto the substrate having a thickness of at least 0.050 mm and less than 0.101 mm.

7. The high speed laser hot wire spraying system of claim 1, wherein the consumable metal wire includes chromium.

8. The high speed laser hot wire spraying system of claim 1, wherein the laser beam is a single beam path laser beam that is not split or recombined within the laser subsystem.

9. The high speed laser hot wire spraying system of claim 1, wherein the laser subsystem operates in the infrared spectrum providing an output power of up to 15 kilowatts.

10. The high speed laser hot wire spraying system of claim 1, wherein the wire feeding device includes a motor and drive rollers.

11. A laser focusing device, the laser focusing device comprising:
a laser light focusing optics module configured to receive laser light, generated by a laser power oscillator, and focus the laser light into a laser beam directed toward a substrate that is external to the laser focusing device;
an inert gas inlet configured to receive an inert gas from a pressurized source of the inert gas that is external to the laser focusing device; and
a high velocity coaxial gas nozzle configured to form and direct, coaxially with the laser beam, a stream of the inert gas toward the substrate,
wherein the laser beam has an energy to liquefy a resistively pre-heated portion of a consumable metal wire that intersects the laser beam external to the laser focusing device, and
wherein the stream of the inert gas has a velocity to cause the resistively pre-heated portion of the consumable metal wire, as liquefied by the laser beam, to be sprayed as liquefied particles onto a surface of the substrate.

12. The laser focusing device of claim 11, further including at least one of a focusing optics cover slide and a focusing optics outlet tip.

13. The laser focusing device of claim 11, wherein spraying of the distal portion of the consumable metal wire as the liquefied particles results in a deposition of a layer of the consumable metal wire onto the substrate having a thickness of at least 0.050 mm and less than 0.101 mm.

14. The laser focusing device of claim 11, wherein the laser beam is a single beam path laser beam that is not split or recombined.

15. The laser focusing device of claim 11, wherein the laser focusing device operates in the infrared spectrum and the laser beam provides an output power of up to 15 kilowatts.

16. A method of applying a metal coating to a substrate, the method comprising:
forming a laser beam with a laser subsystem and directing the laser beam toward a substrate that is external to the laser subsystem;
forming a stream of inert gas that is coaxial with the laser beam using a high velocity coaxial gas nozzle and directing the stream of inert gas toward the substrate;
resistively pre-heating a distal portion of a consumable metal wire with a hot wire subsystem and feeding the distal portion of the consumable metal wire toward the laser beam; and
intersecting the distal portion of the consumable metal wire, as resistively pre-heated and fed, with the laser beam and the stream of inert gas, causing the distal portion of the consumable metal wire to be liquefied by the laser beam and sprayed by the stream of inert gas as liquefied particles onto a surface of the substrate.

17. The method of claim 16, further comprising holding and rotating the substrate with a rotatable fixture as the distal portion of the consumable metal wire is sprayed as the liquefied particles onto the surface of the substrate while rotating.

18. The method of claim 16, further comprising regulating a pressure of the inert gas with a pressure regulator to achieve a velocity of the stream of inert gas out of the high velocity coaxial gas nozzle that allows the liquefied particles to be formed and sprayed.

19. The method of claim 16, further comprising modulating an amplitude of the laser beam with a modulation circuit of the laser subsystem to control an amount of energy of the laser beam delivered to the distal portion of the consumable metal wire.

20. The method of claim 16, wherein the consumable metal wire includes chromium.
